(19) United States
(12) Patent Application Publication
(10) Pub. No.: US 2018/0175765 A1
(43) Pub. Date: Jun. 21, 2018

(54) MOTOR DRIVE CONTROL DEVICE AND MOTOR CONTROL METHOD

(71) Applicant: NIDEC SERVO CORPORATION, Kiryu-shi, Gunma (JP)

(72) Inventor: Masatomo ISHIKAWA, Kiryu-shi (JP)

(21) Appl. No.: 15/735,296

(22) PCT Filed: Jun. 7, 2016
(86) PCT No.: PCT/JP2016/066844

§ 371 Date: Dec. 11, 2017

(30) Foreign Application Priority Data
Jun. 12, 2015 (JP) 2015-118907

(51) Int. Cl. H02P 21/18; H02P 21/22; H02P 27/08; H02P 21/36

(52) U.S. Cl. CPC H02P 21/18; H02P 21/36; H02P 27/08; H02P 21/22

(57) ABSTRACT

A motor drive control device includes a sensorless drive processing unit and a rotation state determining unit, and outputs drive signals to a three-phase voltage type inverter that supplies drive current to a sensorless motor. The sensorless drive processing unit of the motor drive control device performs sensorless drive processing by closed-loop speed control, based on voltage applied to shunt resistance of the inverter. The rotation state determining unit determines a rotation state of the motor when the drive signals are not being output, based on inductive voltage of the motor. The sensorless drive processing unit starts the sensorless drive processing based on determination by the rotation state determining unit.

### BACKGROUND OF THE INVENTION

### 1. Field of the Invention

The present invention relates to a motor drive control device and a motor control method.

### 2. Description of the Related Art

There conventionally has been known sensorless drive processing where a control device driving a brushless DC motor does not have a sensor to detect the position of the rotor of the motor. In common observer-type sensorless drive control devices, the precision of estimation computation deteriorates when the motor is stopped or is rotating at slow speeds. Accordingly, position detection cannot be accurately performed for the motor before starting driving of the motor.

Japanese Unexamined Patent Application Publication No. 2014-110675 describes a position detection method for a motor when the motor is stopped, with a motor drive control device that performs sensorless drive processing (paragraphs 0008 through 0010). Using this method enables the initial position to be detected before rotation of the motor, so appropriate driving control can be performed for a motor that is in a stopped state.

However, in a case where the motor is exposed to the ambient atmosphere, there are cases where the motor is being rotated by an external force before starting driving. In a case where the motor is in a stopped state or a low-speed rotating state, accurate position detection of the motor may not be able to be performed even though starting of the conventional sensorless drive processing is being attempted, leading to a state where the motor is out of synch. On the other hand, in a case where the motor is in a state of rotating backwards, supplying current from the inverter to the motor to perform initial position detection may lead to inverter voltage rising and switching devices within the inverter being destroyed. Accordingly, it is preferable to select a drive method in accordance with the rotation state of the motor, with such motors.

### SUMMARY OF THE INVENTION

An exemplary first invention according to the present application is a motor drive control device that outputs drive signals to a three-phase voltage type inverter that supplies drive current to a sensorless motor. The motor drive control device includes a sensorless drive processing unit that performs sensorless drive processing by closed-loop speed control, based on voltage applied to shunt resistance of the inverter, and a rotation state determining unit that determines a rotation state of the motor when the drive signals are not being output, based on inductive voltage of the motor. The sensorless drive processing unit starts the sensorless drive processing based on determination by the rotation state determining unit.

An exemplary second invention according to the present application is a control method of a motor driven by a three-phase voltage type inverter having shunt resistance. The method includes a) a step of determining a rotation state of the motor, based on inductive voltage of the motor, b) a step of selecting activation processing of the motor from a plurality of activation processing methods, based on the determination results in the step a), and c) a step of performing the activation processing method that has been selected, after the step b). The plurality of activation processing methods include forced-commutation processing where braking and forced rotation of the motor is performed, and sensorless drive transition processing, where the motor in a forward rotation state is transitioned to sensorless drive processing by closed-loop speed control.

### Advantageous Effects of Invention

According to the exemplary first invention and second invention of the present application, appropriate drive signals can be output to the inverter in accordance with the rotation state of the motor. Accordingly, occurrence of a situation where the motor is out of synch, and rise of inverter voltage, can be suppressed even in a case where the motor is rotating under external force or the like before activation.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram illustrating the configuration of a motor drive control device according to an embodiment.

FIG. 2 is a circuit diagram illustrating the configuration of an inverter and voltage divider according to the first embodiment.

FIG. 3 is a flowchart illustrating the flow of drive method determination processing of a motor drive control device according to the first embodiment.

FIG. 4 is a flowchart illustrating the flow of forced-commutation activation processing of the motor drive control device according to the first embodiment.

FIG. 5 is a flowchart illustrating the flow of a sensorless vector control step of the motor drive control device according to the first embodiment.

FIG. 6 is a block diagram of a D-module filter of the motor drive control device according to the first embodiment.

FIG. 7 is a Bode plot of the D-module filter of the motor drive control device according to the first embodiment.

FIG. 8 is a circuit diagram illustrating the configuration of an inverter and voltage divider according to a modification.

FIG. 9 is a circuit diagram illustrating the configuration of an inverter and voltage divider according to another modification.

### DETAILED DESCRIPTION OF THE PREFERRED EMBODIMENTS

An exemplary embodiment of the present invention will be described below with reference to the drawings.

### 1. Configuration of Device

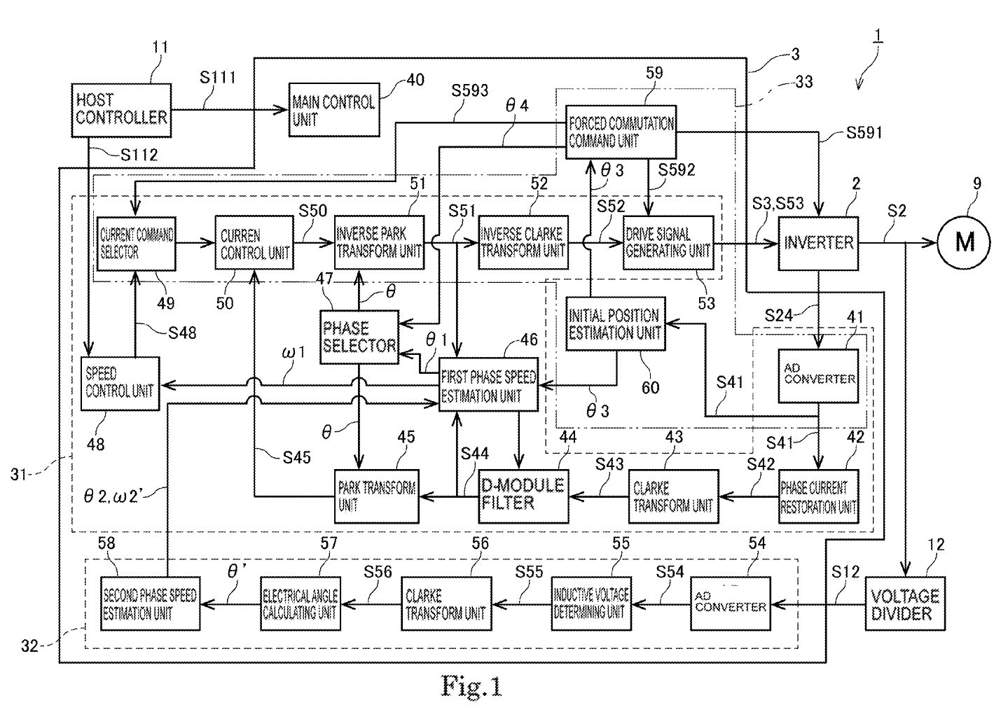

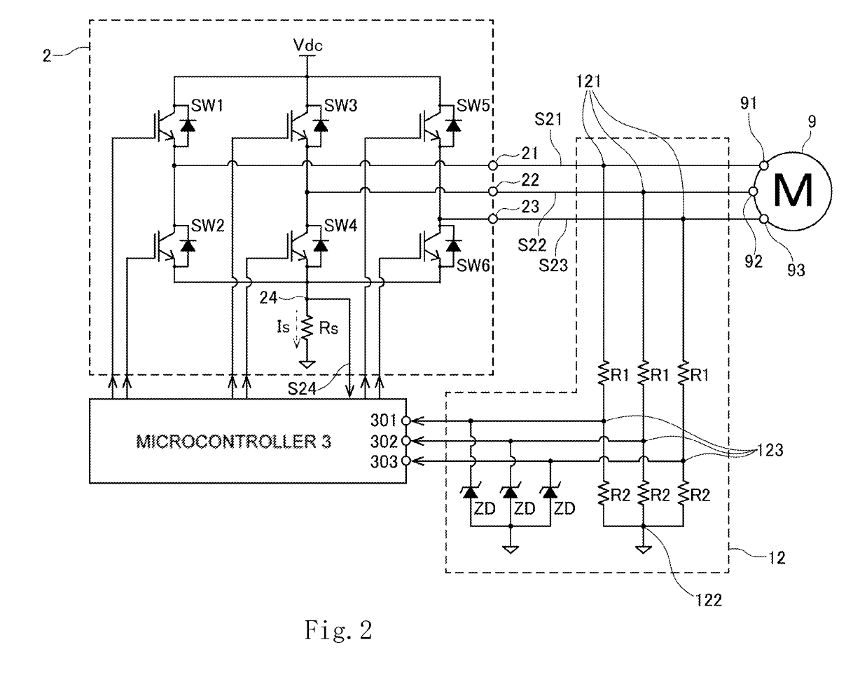

First, the configuration of a motor drive control device 1 will be described with reference to FIGS. 1 and 2. FIG. 1 is a block diagram illustrating the configuration of the motor drive control device 1. FIG. 2 is a circuit diagram schematically illustrating the configuration of an inverter 2 and a voltage divider 12 of the motor drive control device 1 according to the present embodiment.

The motor drive control device 1 is a device that controls driving of a motor 9 my supplying driving current to the motor 9. The motor drive control device 1 has a host controller 11, a voltage divider 12, an inverter 2, and a microcontroller 3, as illustrated in FIG. 1.

The host controller 11 is a device that inputs command signals to the microcontroller 3 for operations such as starting/stopping rotation of the motor 9 and so forth, and target rotation speed of the motor 9 and so forth. Upon a user inputting command signals for operations of the motor 9 or target rotation speed or the like, the host controller 11 inputs a rotation start command signal S111 to a later-described main control unit 40 of the microcontroller 3, and inputs a target rotation speed command signal S112 to a later-described speed control unit 48 of the microcontroller 3.

The voltage divider 12 is a circuit that detects voltage applied to each phase of the three phases of the motor 9. The voltage divider 12 has three input terminals 121, a ground terminal 122, three first resistors R1, three second resistors R2, three output terminals 123, and three Zener diodes ZD, as illustrated in FIG. 2.

Each of the three input terminals 121 is connected to drive current input terminals 91 through 93 for the respective phases of the three phases of the motor 9. The first resistors R1 and second resistors R2 are connected between the input terminals 121 and ground terminal 122. The output terminals 123 are provided between each of the first resistors R1 and second resistors R2. The three output terminals 123 are respectively connected to inductive voltage input terminals 301 through 303. Accordingly, when inductive voltage is generated in the motor 9, inductive voltage S12 for each phase, divided in accordance with the resistance ratio of the first resistors R1 and second resistors R2, is input to the inductive voltage input terminals 301 through 303.

The cathode side ends of the Zener diodes ZD are connected between the output terminals 123 and the inductive voltage input terminals 301 through 303. The anode side ends of the Zener diodes ZD are grounded. Accordingly, excessive voltage can be prevented from being applied to the inductive voltage input terminal 301.

The inverter 2 supplies a drive current S2 to the motor 9 in accordance with a drive signal S3 input from the microcontroller 3. The inverter 2 has a voltage source Vdc, six switching devices SW1 through SW6, a shunt resistance Rs, and three motor connection terminals 21 through 23, as illustrated in FIG. 2. The inverter 2 is a so-called three-phase voltage inverter.

The six switching devices SW1 through SW6 include three pair of switching devices, which are SW1 and SW2 corresponding to U-phase, SW3 and SW4 corresponding to V-phase, and SW5 and SW6 corresponding to W-phase. The switching devices SW1 through SW6 are each made up of a transistor and diode. The switching devices SW1 through SW6 according to the present embodiment use insulated gate bipolar transistors (IGBT), for example. Other types of switching devices may be used for the switching devices SW1 through SW6, such as MOSFETs, which are field effect transistors.

The switching devices SW1 and SW2, switching devices SW3 and SW4, and switching devices SW5 and SW6, are each serially connected between the voltage source Vdc and ground. The switching devices SW1 and SW2, switching devices SW3 and SW4, and switching devices SW5 and SW6, are connected in parallel to each other.

The shunt resistance Rs, which is shared by the three phases, is connected between a connection point of the ground sides of the switching devices SW1 and SW2, switching devices SW3 and SW4, and switching devices SW5 and SW6, and the ground. That is to say, the shunt resistance Rs is serially connected to a ground line shared by the three phases of the inverter 2.

The motor connection terminals 21 through 23 are each connected between the switching devices SW1 and SW2 corresponding to U-phase, switching devices SW3 and SW4 corresponding to V-phase, and switching devices SW5 and SW6 corresponding to W-phase.

When driving the motor 9, the drive signal S3 output from a later-described drive signal generating unit 53 of the microcontroller 3 is input to the six switching devices SW1 through SW6. Accordingly, the drive timing of the switching devices SW1 through SW6 is switched, and drive currents S21 through S23 are output from the motor connection terminals 21 through 23 to the phases of U-phase, V-phase, and W-phase, via the drive current input terminals 91 through 93 of the motor 9.

According to the above-described configuration, the phase current of the U-phase, V-phase, and W-phase of the motor 9 is added and input to the shunt resistance Rs. Accordingly, a shunt current Is flows at the shunt resistance Rs. A shunt current detection terminal 24 is provided at the side of the shunt resistance Rs that is opposite to the ground side. The shunt current detection terminal 24 is connected to the AD converter 41 of the microcontroller 3. When driving the motor 9, shunt voltage S24 placed on the shunt resistance Rs is output from the shunt current detection terminal 24 to an AD converter 41.

The microcontroller 3 generates the drive signal S3 based on the target rotation speed command signal S112 that is externally input, the shunt voltage S24, and the inductive voltage S12 input from the later-described voltage divider 12. The microcontroller 3 outputs the generated drive signal S3 to the inverter 2.

As illustrated in FIG. 1, the microcontroller 3 includes the main control unit 40, the AD converter 41, a phase current restoration unit 42, a Clarke transform unit 43, a D-module filter 44, a Park transform unit 45, a first phase speed estimation unit 46, a phase selector 47, a speed control unit 48, a current command selector 49, a current control unit 50, an inverse Park transform unit 51, and inverse Clarke transform unit 52, a drive signal generating unit 53, an AD converter 54, an inductive voltage determining unit 55, a Clarke transform unit 56, an electrical angle calculating unit 57, a second phase speed estimation unit 58, a forced-commutation command unit 59, and an initial position estimation unit 60.

The microcontroller 3 is a motor drive control device that primarily controls driving of the motor 9 in the motor drive control device 1. Accordingly, the functions of these units are realized by a CPU in the microcontroller 3 operating in accordance with a program. Note that the functions of the microcontroller 3 may be realized by a personal computer or electric circuit instead of a microcontroller.

The main control unit 40 controls operations of the units within the microcontroller 3. Specifically, the main control unit 40 decides which of a later-described sensorless drive processing unit 31, rotation state determining unit 32, and forced-commutation processing unit 33 to operate, based on signals output by the units within the microcontroller 3. The main control unit 40 also performs switching of a later-described phase selector 47 and current command selector 49.

The AD converter 41 performs analog-to-digital conversion of the shunt voltage S24 output from the shunt current detection terminal 24, and outputs digital shunt voltage S41 that has been converted into a digital value to the phase current restoration unit 42 and initial position estimation unit 60.

The phase current restoration unit 42 calculates a restored three-phase current S42 based on the digital shunt voltage S41 input from the AD converter 41, and outputs to the Clarke transform unit 43. The restored three-phase current S42 contains a restored U-phase current Iu where the U-phase current of the motor 9 has been restored, a restored V-phase current Iv where the V-phase current of the motor 9 has been restored, and a restored W-phase current Iw where the W-phase current of the motor 9 has been restored.

The Clarke transform unit 43 performs Clarke transform of the restored three-phase current S42 into an α-β fixed coordinate system and calculates a fixed coordinate system current S43, which is output to the D-module filter 44. The fixed coordinate system current S43 contains an α-axis current Iα and a β-axis current Iβ.

The D-module filter 44 is a first-order lag D-module filter forming the fixed coordinate system current S43. The D-module filter 44 removes ripple noise superimposed on the fixed coordinate system current S43 and calculates a corrected fixed coordinate system current S44, which is output to the Park transform unit 45 and first phase speed estimation unit 46. The corrected fixed coordinate system current S44 contains a corrected α-axis current Iα′ and a corrected β-axis current Iβ′. A specific configuration of the D-module filter 44 will be described later.

The Park transform unit 45 performs Park transform of the corrected fixed coordinate system current S44 to a d-q synchronous rotating coordinate system using a later-described electrical angle θ and calculates a rotating coordinate system current S45, which is output to the current control unit 50. The rotating coordinate system current S45 contains a d-axis current Id and a q-axis current Iq.

The first phase speed estimation unit 46 calculates an electrical angle θ1 of the rotor and an angular speed ω1 of the electrical angle of the rotor, based on the corrected fixed coordinate system current S44 and a later-described fixed coordinate system voltage command value S51. The first phase speed estimation unit 46 outputs the calculated electrical angle θ1 to the phase selector 47, and also outputs the calculated angular speed ω1 of the electrical angle to the speed control unit 48 and D-module filter 44.

Note that while the first phase speed estimation unit 46 according to the present embodiment calculates the electrical angle θ1 and the angular speed ω1 of the electrical angle based on the corrected fixed coordinate system current S44 output from the Clarke transform unit 43 and formed by the D-module filter 44, and on the fixed coordinate system voltage command value S51 output from the inverse Park transform unit 51, the present invention is not restricted to this. The first phase speed estimation unit 46 may be of a configuration where the electrical angle θ1 and the angular speed ω1 of the electrical angle are calculated based on the rotating coordinate system current S45 output from the current control unit 50 and a rotating coordinate system voltage command value S50 output from the current control unit 50.

The phase selector 47 selects one of the electrical angle input from the first phase speed estimation unit 46 and an electrical angle θ4 input from the later-described forced-commutation command unit 59, based on a selection signal from the main control unit 40, and outputs to the Park transform unit 45 and inverse Park transform unit 51 as an electrical angle θ.

The speed control unit 48 calculates a current command value S48 that is a target current value in the d-q synchronous rotating coordinate system, based on a target rotation speed S11 input from the host controller 11, and the angular speed ω input from the first phase speed estimation unit 46, which is output to the current command selector 49. The current command value S48 contains a d-axis current command value Idref and a q-axis current command value Iqref.

The current command selector 49 selects one of the current command value S48 input from the speed control unit 48 and a forced-commutation current command S593 input from the later-described forced-commutation command unit 59, based on a selection signal from the main control unit 40, and outputs to the current control unit 50 as a current command S49.

The current control unit 50 calculates the rotating coordinate system voltage command value S50 based on the current command S49 and the rotating coordinate system current S45. The current control unit 50 then outputs the rotating coordinate system voltage command value S50 to the inverse Park transform unit 51. The rotating coordinate system voltage command value S50 contains a d-axis voltage command value Vd and a q-axis voltage command value Vq, which are voltage command values in the d-q synchronous rotating coordinate system.

The current command value S48 output form the speed control unit 48 is input to the current control unit 50 as the current command S49 in sensorless drive processing. In this case, the current control unit 50 calculates the d-axis voltage command value Vd by performing PI control based on the d-axis current Id of the rotating coordinate system current S45 and d-axis current command value Idref of the current command value S48. The current control unit 50 also calculates the q-axis voltage command value Vq by performing PI control based on the q-axis current Iq of the rotating coordinate system current S45 and q-axis current command value Iqref of the current command value S48. On the other hand, in forced-commutation processing, the forced-commutation current command S593 output from the forced-commutation command unit 59 is input to the current control unit 50 as the current command S49. In this case, the current control unit 50 calculates the d-axis voltage command value Vd and q-axis voltage command value Vq of the rotating coordinate system current S45 based on a d-axis forced-communication current command value Idfref and q-axis Iqfref of the later-described forced-commutation current command S593.

The inverse Park transform unit 51 uses the electrical angle θ to perform inverse Park transform of the rotating coordinate system voltage command value S50 to the α-β fixed coordinate system and calculate the fixed coordinate system voltage command value S51, which is output to the inverse Clarke transform unit 52. The fixed coordinate system voltage command value S51 contains an α-axis voltage command value vα and a β-axis voltage command value Vβ that are voltage command values in the α-β fixed coordinate system.

The inverse Clarke transform unit 52 performs inverse Clarke transform of the fixed coordinate system voltage command value S51 into three phases and calculates a phase voltage command value S52, and outputs to the drive signal generating unit 53. The phase voltage command value S52 contains Vu, Vv, and Vw, which are voltage command values corresponding to the three phases.

The drive signal generating unit 53 generates the drive signal S3 based on the phase voltage command value S52, which is output to the inverter 2.

In the present embodiment, the sensorless drive processing unit 31 that performs the sensorless drive processing step is configured of the main control unit 40, AD converter 41, phase current restoration unit 42, Clarke transform unit 43, D-module filter 44, Park transform unit 45, first phase speed estimation unit 46, phase selector 47, speed control unit 48, current command selector 49, current control unit 50, inverse Park transform unit 51, inverse Clarke transform unit 52, and drive signal generating unit 53. According to this configuration, the sensorless drive processing unit 31 performs closed-loop speed control based on voltage applied to the shunt resistance Rs of the inverter 2.

The AD converter 54 performs analog-to-digital conversion of each inductive voltage S12 output from the voltage divider 12, and outputs a digital inductive voltage S54 that has been converted into a digital value, to the inductive voltage determining unit 55. The digital inductive voltage S54 contains digital inductive voltage values Eu, Ev, and Ew, where the inductive voltage generated within the motor 9 has been divided and also digitized.

The inductive voltage determining unit 55 determines whether or not the rotation state of the motor 9 is a first low-speed rotation state, based on the digital inductive voltage S54. Specifically, in a case where the magnitude of the amplitude value of Ei of the digital inductive voltage values Eu, Ev, and Ew of the three phases is smaller than a predetermined threshold voltage Eth, determination is made that the state is the first low-speed rotation state, and a determination result is transmitted to the main control unit 40. In the other hand, in a case where the magnitude of the amplitude value of Ei is the threshold voltage Eth or greater, the digital inductive voltage S54 input from the AD converter 54 is handed over to the Clarke transform unit 56.

The Clarke transform unit 56 performs Clarke transform of the digital inductive voltage S54 to an α-β fixed coordinate system and calculates a fixed coordinate system inductive voltage S56, and outputs to the electrical angle calculating unit 57. The fixed coordinate system inductive voltage S56 contains an α-axis inductive voltage Eα and a β-axis inductive voltage Eβ.

The electrical angle calculating unit 57 calculates a sampling electrical angle θ′ based on the fixed coordinate system inductive voltage S56, and outputs to the second phase speed estimation unit 58. Specifically, the sampling electrical angle θ′ for each sampling cycle is calculated by arctangent computation of a value obtained by dividing the α-axis inductive voltage Eα by the β-axis inductive voltage Eβ.

The second phase speed estimation unit 58 calculates the electrical angle θ2 of the rotor and the angular speed ω2 of the electrical angle of the rotor, based on the sampling electrical angle θ′. The second phase speed estimation unit 58 outputs the calculated electrical angle θ2 and a final value ω2′ of the angular speed ω2 to the first phase speed estimation unit 46.

In the present embodiment, the main control unit 40, AD converter 54, inductive voltage determining unit 55, Clarke transform unit 56, electrical angle calculating unit 57, and second phase speed estimation unit 58 make up the rotation state determining unit 32. Upon being input with the rotation start command signal S111, the main control unit 40 first drives the rotation state determining unit 32. The rotation state determining unit 32 then decides the action to take next, based on the angular speed ω2.

The forced-commutation command unit 59 proceeds with forced-commutation processing. Upon being input with a forced-commutation processing start command from the main control unit 40, based on this command the forced-commutation command unit 59 outputs a braking command 591 to the inverter 2 during a braking time Tb. During the period of input of the braking command 591, the inverter 2 performs short braking, thereby braking rotation of the motor 9.

When output of the braking command S591 ends, the forced-commutation command unit 59 outputs a position estimation command S592 to the drive signal generating unit 53. Accordingly, the drive signal generating unit 53 outputs a weak pulse signal S53, which is a weak electrical signal, to the inverter 2. Note that the weak pulse signal S53 is sufficiently small as compared to a normal drive signal S3, so no rotations are generated at the motor 9 even if the weak pulse signal S53 is input to the inverter 2.

The initial position estimation unit 60 detects an electrical angle θ3 of the motor 9 in the stopped state. Specifically, upon the drive signal generating unit 53 outputting the weak pulse signal S53 to the inverter 2 in accordance with the position estimation command S592, the shunt voltage S24 corresponding to the electrical angle of the motor 9 is input to the AD converter 41. Accordingly, the digital shunt voltage S41 corresponding to the electrical angle of the motor 9 is input to the initial position estimation unit 60. The initial position estimation unit 60 calculates the electrical angle θ3 of the motor based on this digital shunt voltage S41, and outputs to the first phase speed estimation unit 46 and forced-commutation command unit 59.

Upon detection of the electrical angle θ3 by the initial position estimation unit 60 based on the position estimation command S592 ending, the forced-commutation command unit 59 then outputs a forced-commutation angle θ4 to the phase selector 47, and outputs the forced-commutation current command value S593 to the current command selector 49. The forced-commutation current command value S593 contains a d-axis forced-communication current command value Idfref and q-axis Iqfref.

In the present embodiment, the forced-commutation processing unit 33 is configured of the main control unit 40, AD converter 41, current command selector 49, current control unit 50, inverse Park transform unit 51, inverse Clarke transform unit 52, drive signal generating unit 53, forced-commutation command unit 59, and initial position estimation unit 60.

### 2. Operations of Microcontroller

### 2-1. Driving Method Determination Processing

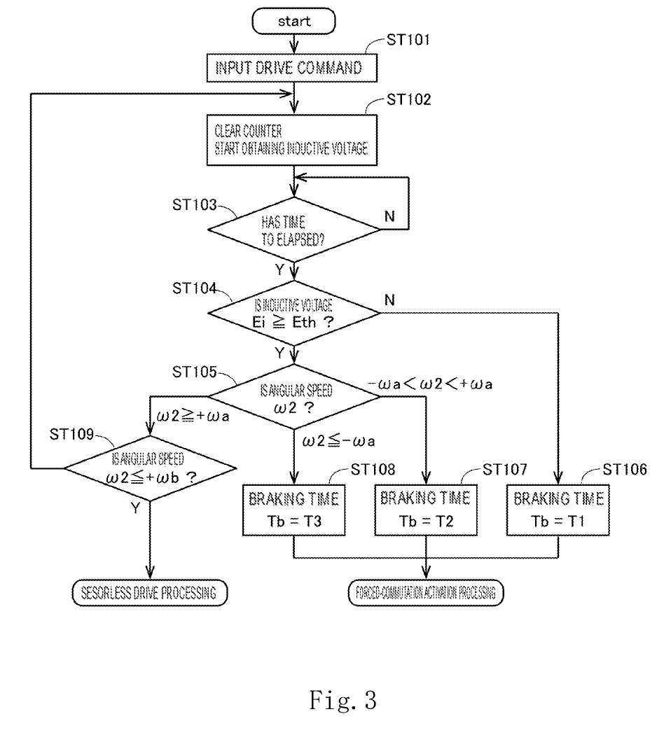

Next, the operations of the microcontroller 3 will be described with reference to the drawings. First, the driving method determination processing that the microcontroller 3 performs will be described with reference to FIG. 3. FIG. 3 is a flowchart illustrating the flow of the driving method determination processing at the microcontroller 3 when staring driving of the motor 9. In the control method of the motor 9 using the motor drive control device 1 according to the present embodiment, activation processing of the motor 9 is performed by the following procedures.

First, the rotation start command signal S111 is input from the host controller 11 to the main control unit 40 of the microcontroller 3 in step ST101. Accordingly, the main control unit 40 starts driving method determination processing. The main control unit 40 then clears a counter that measures elapsed time, and sets elapsed time Tp to Tp=0. In step ST102, the main control unit 40 drives the rotation state determining unit 32 and starts acquisition of inductive voltage S12 via the voltage divider 12 at the same time. Accordingly, the AD converter 54 performs analog-to-digital conversion of the inductive voltage S12 for each sampling cycle, and the digital inductive voltage S54 is obtained.

Subsequently, in step ST103, the main control unit 40 determines whether or not time T0 has elapsed from clearing of the counter, i.e., whether or not Tp≥T0 holds. In a case where determination is made by the main control unit 40 that Tp<T0 holds, the microcontroller 3 returns to step ST103 and stands by. On the other hand, in a case of the main control unit 40 determining that Tp≥T0 holds, in step ST104 the main control unit 40 performs determination by the voltage value of the digital inductive voltage S54 by the inductive voltage determining unit 55.

Specifically, in step ST104, determination is made regarding whether or not the amplitude value Ei of the digital inductive voltage values Eu, Ev, and Ew of the three phases of the digital inductive voltage S54 within a predetermined period is at the threshold voltage Eth or above. In a case where the amplitude value Ei is smaller than the threshold voltage Eth, determination is made that the state is the first low-speed rotation state where the voltage value of the digital inductive voltage S54 is smaller than a predetermined magnitude, and the flow advances to ST106. In step ST106, the braking time Tb where short braking is performed as to the inverter 2 is set to Tb=T1. The flow then transitions to forced-commutation activation processing.

Definition of the rotation state of the motor 9 will be described here. In the present embodiment, the rotation state of the motor 9 is determined to be one of the first low-speed state, second low-speed state, reverse rotation state, forward rotation state, and high-speed forward rotation state.

The first low-speed state is a state where the amplitude value of Ei of the digital inductive voltage values Eu, Ev, and Ew of the three phases of the digital inductive voltage S54 during the predetermined period is smaller than the predetermined threshold voltage Eth, as described above. The second low-speed state is a state where the absolute value of the angular speed ω2 of the electrical angle of the motor 9 calculated by the rotation state determining unit 32 is smaller than a predetermined threshold value ωa, and is not the first low-speed state. The first low-speed state and second low-speed state include a case where the rotation direction of the motor 9 is forward rotation, a case where the rotation direction of the motor 9 is reverse rotation, and a case where the motor 9 is in a stopped state.

Reverse rotation state is a state where the angular speed ω2 belongs to a predetermined speed range in the reverse direction expressed by ω2−ωa. That is to say, the reverse rotation state is a state where the rotation of the motor 9 is in the reverse direction, and also where the absolute value of the angular speed ω2 is the predetermined threshold value ωa or greater.

Forward rotation state is a state where the angular speed ω2 belongs to a forward speed range that is a predetermined speed range in the forward direction expressed by +ωa≤ω2−ωb. That is to say, the forward rotation state is a state where the rotation of the motor 9 is in the forward direction, and also where the absolute value of the angular speed ω2 is the predetermined threshold value ωa or greater but a predetermined threshold value ωb or smaller. Also, the high-speed rotation state is a state where the angular speed ω2 is ω2>ωb, i.e., where the angular speed ω2 is in the forward direction and is greater than a forward rotation speed range. That is to say, the high-speed rotation state is a state where the rotations of the motor 9 are in the forward direction, and the absolute value of the angular speed ω2 exceeds the predetermined threshold value ωb.

In step ST104, in a case where the amplitude value of Ei is at the threshold voltage Eth or above, the flow advances to ST105. The main control unit 40 drives the Clarke transform unit 56, electrical angle calculating unit 57, and second phase speed estimation unit 58, to calculate, from the digital inductive voltage S54, the fixed coordinate system inductive voltage S56, sampling electrical angle θ′, electrical angle θ2, and angular speed ω2 of the electrical angle. The range to which the angular speed ω2, representing the rotation speed of the motor 9, belongs, is determined in ST105. Accordingly, the rotation state of the motor 9 is determined to be one of second low-speed state, reverse rotation state, and forward rotation state. Specifically, determination is made to which of −ωa<ω2<+ωa, ω2≤−ωa, and ω2≥ωa, that the angular speed ω2 belongs to.

In a case where determination is made in step ST105 by the main control unit 40 that the angular speed ω2 belongs to the range of −ωa<ω2<+ωa, i.e., that the rotation state of the motor 9 is the second low-speed state, the flow advances to step ST107. In step ST107, the braking time Tb for performing short braking regarding the inverter 2 is set to Tb=T2. The flow then transitions to forced-commutation activation processing. Note that the braking time T2 in the second low-speed state may be the same time as the braking time T1 in the first low-speed state, or may be longer than the braking time T1 in the first low-speed state.

Thus, the microcontroller 3 according to the present embodiment performs step ST104 before step ST105. The amount of calculations in step ST105 is greater than the amount of calculations in step ST104, so it takes time to calculate the results. Accordingly, in a case where determination can be made just by the magnitude of the inductance voltage obtained in step ST104, determination is made that the state is low speed rotation without waiting for calculation of each speed ω2 in step ST105, and transitioning to forced-commutation processing is performed. Accordingly, the motor 9 can be quickly and smoothly started.

On the other hand, in a case where determination is made by the main control unit 40 that the angular speed ω2 belongs to the range of ω2−ωa in step ST105, i.e., that the rotation state of the motor 9 is a reverse rotation state, the flow advances to step ST108. In step ST108, braking time Tb for performing short braking regarding the inverter 2 is set to Tb=T3. The flow then transitions to forced-commutation activation processing. Note that the braking time T3 in the reverse rotation state is longer than the braking time T1 in the first low-speed state and the braking time T2 in the second low-speed state. Note that, however, the braking time T2 in the second low-speed state and the braking time T3 in the reverse rotation state may be a variable value that increases as the angular speed ω2 increases.

Thus, in a case of the rotation state determining unit 32 determining that the rotation state of the motor 9 is the first low-speed state, second low-speed state, or reverse rotation state, transitioning to forced-commutation processing is performed. That is to say, forced-commutation processing is started if the rotation state determining unit 32 determines that the angular speed ω2, which is the motor speed, is in the forward direction and also is smaller than the forward rotation speed range, or is in the reverse direction.

In a case where the main control unit 40 determines in step ST105 that the angular speed ω2 belongs to the range of ω2+ωa, i.e., that the rotation state of the motor 9 is the forward rotation state or high-speed forward rotation state, the flow advances to step ST109. The main control unit 40 then in step ST109 determines whether or not the angular speed ω2 is at or below a predetermined threshold value ωb.

In a case where the main control unit 40 determines in step ST109 that the angular speed ω2 is ωb or lower, i.e., that the rotation state of the motor 9 is the forward rotation state, sensorless drive transition processing is performed to transition to sensorless drive processing. Thus, sensorless drive processing and be started quickly and smoothly.

On the other hand, in a case where determination is made that the angular speed ω2 is greater than ωb, i.e., that the rotation state of the motor 9 is the high-speed forward rotation state, the flow returns to step ST102 without performing drive starting processing of the motor 9. In a case where the motor 9 is rotating forward at a speed faster than the desired rotation speed, there is no need to start driving. Accordingly, going to a standby state in this way suppressed unnecessary consumption of electric power.

In this way, upon the rotation start command signal S111 being input in steps ST103 through ST105 and ST109, the main control unit 40 first drives the rotation state determining unit 32 and determines the rotation state of the motor 9 based on the inductive voltage of the motor 9.

The main control unit 40 then selects the activation method from forced-communication activation processing and sensorless drive transition processing, based on the determination results of the rotation state.

Upon transitioning from the drive method determination processing to forced-communication activation processing, based on the determination results of the rotation state, the main control unit 40 performs the later-described forced-communication activation processing.

On the other hand, in a case of performing sensorless drive transition processing based on the determination results of the rotation state, the main control unit 40 first sets the electrical angle θ2 that the second phase speed estimation unit 58 outputs to the initial value of the electrical angle θ1 of the first phase speed estimation unit 46. At the same time, the main control unit 40 sets the angular speed ω2 that the second phase speed estimation unit 58 outputs, to the initial value of the angular speed θ1 of the electrical angle of the first phase speed estimation unit 46.

Subsequently, upon input of the electrical angle θ1 from the first phase speed estimation unit 46 to the phase selector 47 starting, the main control unit 40 sets the electrical angle θ output by the phase selector 47 to the electrical angle θ1 output by the first phase speed estimation unit 46.

Thus, selection is made between whether to immediately transition to sensorless drive processing, or whether to perform forced-communication processing and then transition to sensorless drive processing, by the rotation state determining unit 32 determining the rotation state of the motor. Accordingly, an appropriate activation method can be selected in accordance with the rotation state. Thus, occurrence of a situation where the motor is out of synch, and rise of inverter voltage, can be suppressed.

### 2-2. Forced-Commutation Activation Processing

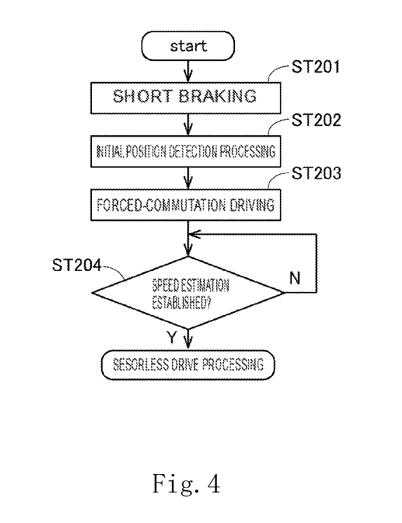

Next, the forced-commutation activation processing that the microcontroller 3 performs will be described with reference to FIG. 4. FIG. 4 is a flowchart illustrating the flow of the forced-commutation activation processing at the forced-commutation processing unit 33 of the microcontroller 3.

First, in step ST201, the forced-commutation command unit 59 outputs the braking command S591 to the inverter 2 during the braking time Tb set in steps ST106 through ST108 in the drive method determination processing. Accordingly, the inverter 2 carries out short braking during the period of the braking time Tb. As a result, rotation of the motor 9 stops.

Next, the forced-commutation command unit 59 outputs the position estimation command S592 to the drive signal generating unit 53. The drive signal generating unit 53 outputs the weak pulse signal S53, which is a weak electrical signal, to the inverter 2 in accordance with the position estimation command S592. Accordingly, a weak drive current S2 corresponding to the weak pulse signal S53 is supplied from the inverter 2 to the motor 9, and the shunt current Is corresponding to the electrical angle of the motor flows at the shunt resistance Rs of the inverter 2. The AD converter 41 detects this shunt voltage S24 applied to the shunt resistance Rs, converts into the digital shunt voltage S41, and outputs to the initial position estimation unit 60. The initial position estimation unit 60 calculated the electrical angle θ3 of the motor 9 in step ST202, based on the digital shunt voltage S41. The main control unit 40 sets the electrical angle θ3 estimated at the initial position estimation unit 60 as the initial electrical angle of the first phase speed estimation unit 46 and forced-commutation command unit 59.

Subsequently, the forced-commutation command unit 59 outputs a forced-commutation current electrical angle θ4 to the phase selector 47, and outputs the forced-commutation current command S593 to the current command selector 49. Accordingly, the current control unit 50 outputs the rotating coordinate system voltage command value S50 based on the forced-commutation current command value S593, and the phase voltage command value S52 is input to the drive signal generating unit 53 via the inverse Park transform unit 51 and inverse Clarke transform unit 52. As a result, in step ST203, the drive signal generating unit 53 outputs the drive signal S3 for forced commutation to the inverter 2 in order to start rotation of the motor 9, and starts forced-commutation processing.

Upon forced-commutation driving being started, the main control unit 40 causes the first phase speed estimation unit 46 of the sensorless drive processing unit 31 to start calculation of the angular speed ω1 of the electrical angle of the motor 9 The main control unit 40 then determines in step ST204 whether or not estimation of speed by the first phase speed estimation unit 46 has been established, based on the value of the angular speed ω1.

The determination in step ST204 of whether or not estimation of speed by the first phase speed estimation unit 46 has been established is determined based on whether or not the value of the angular speed ω1 calculated by the first phase speed estimation unit 46 is at a predetermined threshold value or above, and whether or not the value of the angular speed ω1 calculated by the first phase speed estimation unit 46 is being output in a stable manner. In a case where the main control unit 40 determines that estimation of speed by the first phase speed estimation unit 46 has not been established in step ST204, the flow returns to step ST204.

On the other hand, in a case of the main control unit 40 determining in step ST204 that estimation of speed by the first phase speed estimation unit 46 has been established, the forced-commutation activation processing is ended, and transition is made to sensorless drive processing. At the time of transitioning from commutation activation processing to sensorless drive processing, the main control unit 40 switches the electrical angle θ that the phase selector 47 outputs from the forced-commutation electrical angle θ4 that the forced-commutation command unit 59 outputs to the electrical angle θ1 that the first phase speed estimation unit outputs. Also, at the time of transitioning from forced-commutation activation processing to sensorless drive processing, the main control unit 40 switches the current command value S49 that the current command selector 49 outputs from a forced-commutation current command value S59 that the forced-commutation command unit 59 outputs to the current command value S48 that the speed control unit 48 outputs.

Thus, in the forced-commutation processing, the forced-commutation processing unit 33 outputs the drive signal S3 for forced commutation to the inverter 2 after having performed short braking processing at the inverter 2. Accordingly, due to having temporarily stopped the motor by performing short braking, forced-commutation processing can be performed without occurrence of a situation where the motor is out of synch, or rise of inverter voltage.

### 2-3. Sensorless Drive Processing

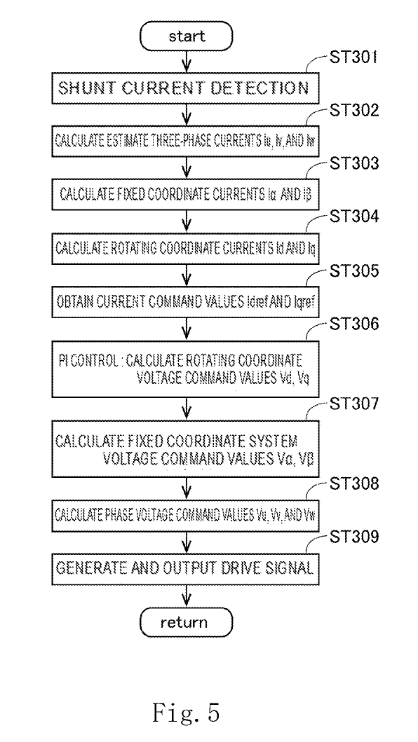

Next, sensorless drive processing that the microcontroller 3 performs will be described with reference to FIG. 5. FIG. 5 is a flowchart illustrating the flow of sensorless drive processing at the sensorless drive processing unit 31 of the microcontroller 3.

First, in step ST301, the microcontroller 3 detects the shunt current Is flowing at the shunt resistance Rs of the inverter 2. Specifically, the shunt voltage S24 detected from the shunt current detection terminal 24 of the inverter 2 is input to the microcontroller 3. The shunt voltage S24 is converted into a digital shunt voltage S41 at the AD converter 41, and input to the phase current restoration unit 42.

Next, in step ST302, the phase current restoration unit 42 calculates the restored three-phase current S42, i.e., restored three-phase currents Iu, Iv, and Iw, based on the digital shunt voltage S41.

The Clarke transform unit 43 in step ST303 transforms the restored three-phase currents Iu, Iv, and Iw into an α-β fixed coordinate system and calculates the fixed coordinate system current S43, which is fixed coordinate system currents Iα and Iβ. The D-module filter 44 forms the fixed coordinate system currents Iα and Iβ and calculates the corrected fixed coordinate system current S44, i.e., corrected fixed coordinate system currents Iα′ and Iβ′. The corrected fixed coordinate system current S44 is output to the Park transform unit 45 and first phase speed estimation unit 46.

Thereafter, in step ST304, the Park transform unit 45 transforms the corrected fixed coordinate system currents Iα′ and Iβ′ into a d-q synchronous rotating coordinate system, and calculates the rotating coordinate system current S45, i.e., rotating coordinate system currents Id and Iq. The electrical angle θ1 of the motor 9 and the angular speed ω1 of the electrical angle are calculated at the first phase speed estimation unit 46. The electrical angle θ1 is then output to the Park transform unit 45 and inverse Park transform unit 51 via the phase selector 47. The angular speed ω1 of the electrical angle is output to the speed control unit 48.

The speed control unit 48 calculates the current command value S48 based on the target rotation speed command signal S112 input from the host controller 11, and the angular speed ω1 of the electrical angle. Thus, the d-axis current command value Idref and q-axis current command value Iqref are obtained in step ST305. Note that step ST305 may be performed before steps ST301 through ST304, or may be performed in parallel with steps ST301 through ST304.

Next, in step ST306, the current control unit 50 calculates the voltage command value S50, which is voltage command values Vd and Vq, based on the rotating coordinate system currents Id and Iq, and current command values Idref and Iqref.

In step S306, calculation of the voltage command values Vd and Vq is performed by PI control. PI control is a control method where proportional control (P control) where amplification control is performed in accordance with the difference between an ideal value and a measured value, and integral control (I control) where amplification control is performed in accordance with the integrated value of the difference between an ideal value and a measured value, are combined. Accordingly, the d-axis voltage command value Vd is obtained from the difference between the d-axis current Id and the d-axis current command value Idref, while the q-axis voltage command value Vq is obtained from the difference between the q-axis current Iq and the q-axis current command value Iqref.

Note that calculation of the voltage command values Vd and Vq may be performed by a control method other than PI control. For example, calculation of the voltage command values Vd and Vq may be performed by other control methods such as P control, PD control, PID control, and so forth.

Thus, by transforming the restored phase currents Iu, Iv, and Iw, where phase currents flowing at each phase of the motor 9 have been restored, into a d-q synchronous rotating coordinate system in step ST303, control can be performed in step ST306 using the rotating coordinate system currents Id and Iq that can be deemed to be DC current. Accordingly, the motor 9 can be controlled by a q-axis representing torque properties and d-axis representing magnetic flux properties, so the two properties of rotational speed and torque can be controlled without using a complicated control method.

Thereafter, in step ST307, the inverse Park transform unit 51 transforms the voltage command values Vd and Vq into an α-β fixed coordinate system, and calculates the fixed coordinate system voltage command value S51, i.e., fixed coordinate system voltage command values vα and vβ. In step S308 the inverse Clarke transform unit 52 converts the fixed coordinate system voltage command values vα and vβ into three phases, and calculates the phase voltage command value S52, i.e., phase voltage command values Vu, Vv, and Vw.

Next, the drive signal S3, which is a PWM signal, is generated at the drive signal generating unit 53 in step ST309, based on the phase voltage command values Vu, Vv, and Vw, and is output to the inverter 2.

### 3. Configuration of D-Module Filter

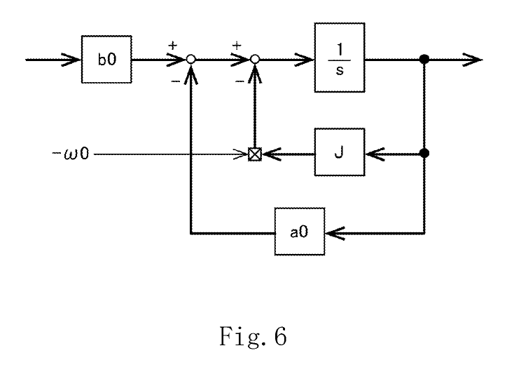

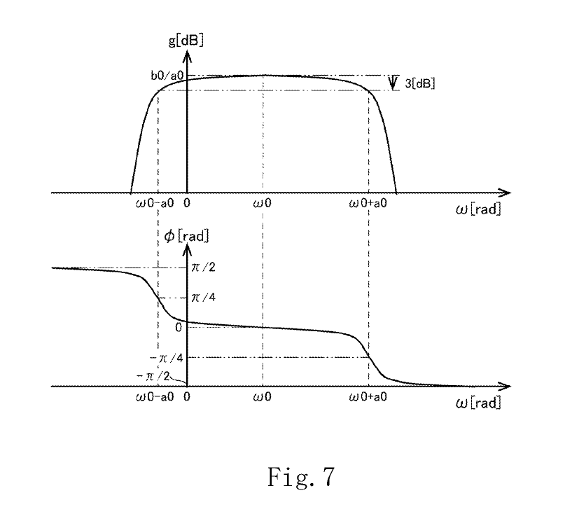

Next, the configuration of the D-module filter 44 will be described with reference to FIG. 6. FIG. 6 is a block diagram illustrating the configuration of the D-module filter 44 according to the present embodiment. FIG. 7 is a Bode plot of the D-module filter 44.

The D-module filter 44 illustrated in FIG. 6 is a filter based on a first-order lag low-pass filter, to which a two-input two-output D-module has been applied. The coordinate system current S43 output from the Clarke transform unit 43 is input to the D-module filter 44, formed, and thus the corrected fixed coordinate system current S44 with noise removed is output. Now, the coordinate system current S43 input to the D-module filter 44 shall be expressed by the second-order column vector in the following expression. Note that in the following Expression (1), the Laplace operator is expressed by “s”.

$$I α β ( s ) = [ \begin{matrix}I α ( s ) \\ I β ( s )\end{matrix} ] \qquad ( 1 )$$

Further, the corrected fixed coordinate system current S44 output from the D-module filter 44 shall be expressed by the second-order column vector in the following expression.

$${I }^{′} α β ( s ) = [ \begin{matrix}{I }^{′} α ( s ) \\ {I}^{′} β ( s )\end{matrix} ] \qquad ( 2 )$$

Note that the matrix denoted by J in FIG. 6 is a second-order alternative matrix shown in the following expression.

$$J = [ \begin{matrix}0 & - 1 \\ 1 & 0\end{matrix} ] \qquad ( 3 )$$

In such a D-module filter 44, the output corrected fixed coordinate system current S44 is the value illustrated in the following expression.

$$\begin{matrix}{I}^{′} αβ ( s ) = \frac{b 0}{D ( s , ω 0 ) + a 0} \cdot I α β ( s ) & ( 4 ) \\ D ( s , ω 0 ) = s I + ω 0 J = s [ \begin{matrix}1 & 0 \\ 0 & 1\end{matrix} ] + ω 0 [ \begin{matrix}0 & - 1 \\ 1 & 0\end{matrix} ] = [ \begin{matrix}s & - ω 0 \\ ω 0 & s\end{matrix} ] & ( 5 )\end{matrix}$$

The angular speed ω1 output from the first phase speed estimation unit 46 is input to this D-module filter 44 as a shift signal ω0. Accordingly, the D-module filter 44 serves as a band-pass filter having a band of ±a0 [rad] centered on shift signal ω0 [rad], as illustrated in the gain plot in FIG. 7. That is to say, the D-module filter 44 can extract the drive frequency component in a sure manner even if the angular speed ω1 varies.

Also, the phase shift ϕ[rad] becomes 0 [rad] in the proximity of shift signal ω0, as illustrated in the phase plot in FIG. 7. That is to say, the D-module filter 44 can extract the drive frequency component without phase lag even if the angular speed ω1 varies.

The sensorless drive processing unit 31 according to the present embodiment performs one-shunt sensorless vector control. Accordingly, ripple noise is superimposed on the restored three-phase current S42 as compared to a case of performing three-shunt control. Accordingly, the ripple noise is also superimposed on the fixed coordinate system current S43. Accordingly, applying this D-module filter 44 to the coordinate system current S43 enables sine waves with no lag phase to be formed.

Note that a first-order lag D-module filter may perform filtering on the restored three-phase current S42 or rotating coordinate system current S45, instead of the fixed coordinate system current S43. Note however, that in a case of performing filtering on the restored three-phase current S42, the filter will be a three-input three-output filter where input and output is expressed by a third-order column vector. In this case, the matrix J is a third-order alternative matrix, instead of the second-order alternative matrix shown above.

Performing filtering on the restored three-phase current S42 increases the amount of calculations as compared to the case of two-input two-output, so filtering of the coordinate system current S43 or rotating coordinate system current S45 is preferable.

In the present embodiment, the first phase speed estimation unit 46 calculates the electrical angle θ1 and the angular speed ω1 based on the values of the fixed coordinate system. Accordingly, the first phase speed estimation unit 46 receives input of the coordinate system current S43 that has been filtered.

### 4. Modifications

Although an exemplary embodiment of the present invention has been described above, the present invention is not restricted to the above-described embodiment.

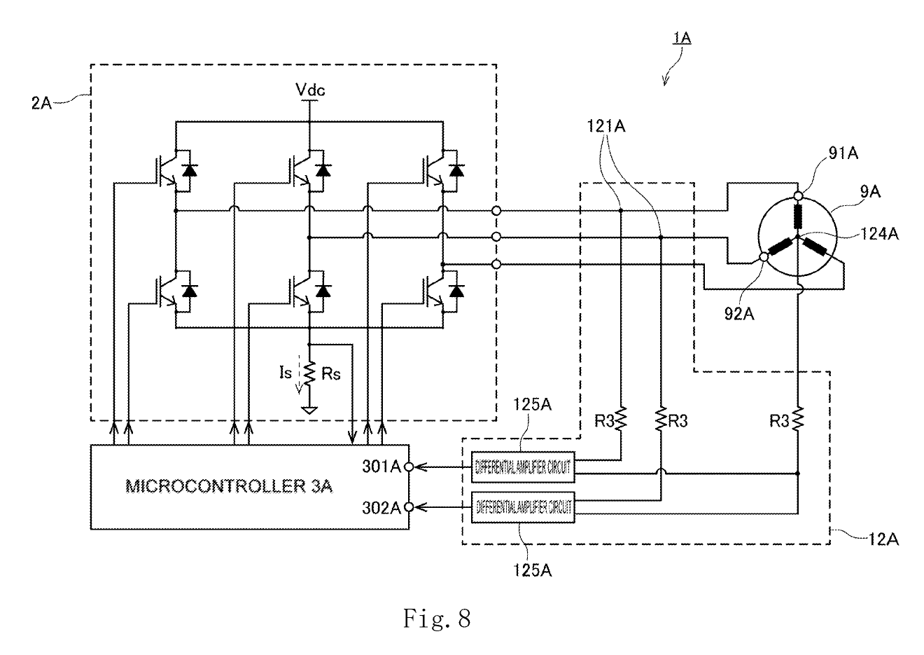

FIG. 8 is a circuit diagram of the configuration of an inverter 2A and comparison circuit 12A in a motor drive device 1A according to a modification. This motor drive device 1A is a device that drives a motor 9A, which is a star-connection three-phase motor.

This comparison circuit 12A is a circuit that detects phase voltage applied to each of two phases of the three phases of the motor 9A. The comparison circuit 12A has two phase input terminals 121A, three third resistors R3, one neutral input terminal 124A, and two differential amplifier circuits 125A.

The two differential amplifier circuits 125A each output a voltage value, obtained by amplifying the difference between a voltage value input to the first terminal and a voltage value input to the second terminal, to inductive voltage input terminals 301A and 302A of a microcontroller 3A. The amplification factor at the differential amplifier circuits 125A is 1 or smaller in the example in FIG. 8, so application of excessive voltage to the inductive voltage input terminals 301A and 302A of the microcontroller 3A is prevented.

The two phase input terminals 121A are each connected to one of the drive current input terminals 91A and 92A of two phases out of the three phases of the motor 9A. The phase input terminals 121A are each connected to a first terminal of the differential amplifier circuits 125A via the third resistors R3. The neutral input terminal 124A is connected to a neutral point of the motor 9A. The neutral input terminal 124A is also connected to a second terminal of each of the differential amplifier circuits 125A via the third resistors R3.

Accordingly, the differential amplifier circuits 125A outputs voltage values corresponding to the phase voltage of each of the two phases out of the three phases of the motor 9A, to the inductive voltage input terminals 301A and 302A. The microcontroller 3A acquires phase voltage of two phases out of the three phases of the motor 9A, and thereby calculates the phase voltage of the remaining phase.

The voltage of the coil terminals for each of the three phases of the motor 9 has been described in the embodiment above as being input to the microcontroller 3 as inductive voltage S12. Accordingly, the inductive voltage determining unit 55 calculates the line voltage from the three voltage values, which are the voltage of the coil terminals of each phase, and further calculates three-phase phase voltage from the three line voltages. As long as the microcontroller 3 has the three inductive voltage input terminals 301 through 303, phase voltage for each of the three phases can be obtained simply by inputting the voltages of the coil terminals for all three phases to the microcontroller 3.

However, in a case where the number of inductive voltage input terminals is great, the number of corresponding AD converters also increases. The example in FIG. 8 enables the number of inductive voltage input terminals and the number of AD converters in the microcontroller 3A to be used for rotation state determining processing to be reduced.

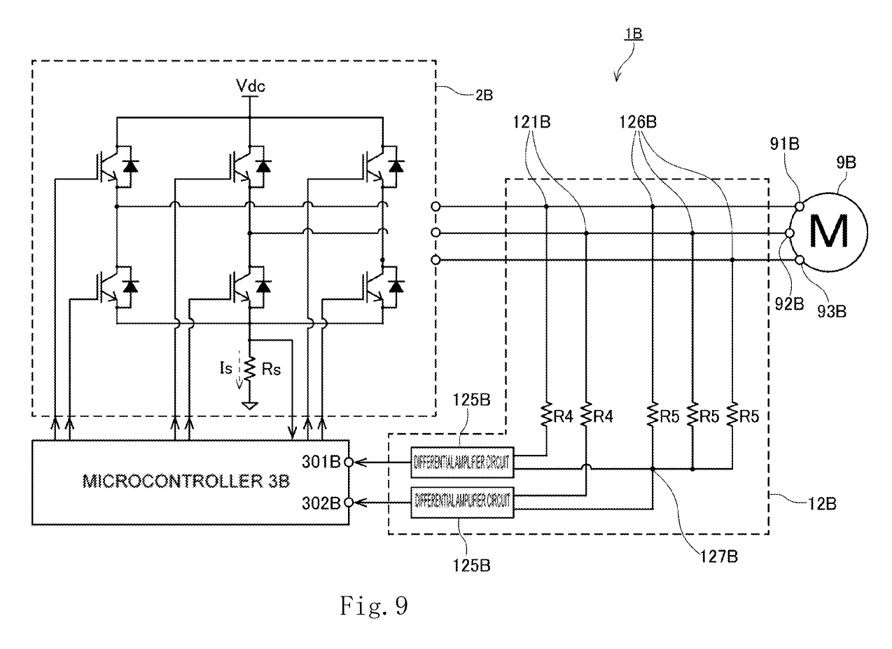

FIG. 9 is a circuit diagram illustrating the configuration of an inverter 2B and a comparison circuit 12B in a motor drive device 1B according to another modification. This motor drive device 1B is a device for driving a motor 9B that is a delta connection three-phase motor, or a star connection three-phase motor where connection cannot be made to a neutral point.

This comparison circuit 12B is a circuit that detects phase voltage applied to two phases of the three phases of the motor 9B. The comparison circuit 12B has two first phase input terminals 121B, two fourth resistors R4, three second phase input terminals 126B, three fifth resistors R5, a virtual neutral output terminal 127B, and two differential amplifier circuits 125B. The two differential amplifier circuits 125B have the same configuration as the differential amplifier circuits 125A in the example in FIG. 8.

The two first phase input terminals 121B are each connected to one of the drive current input terminals 91B and 92B of each of two phases out of the three phases of the motor 9B. The first phase input terminals 121B are each connected to a first terminal of the differential amplifier circuits 125B via the fourth resistors R4.

The three second phase input terminals 126B are each connected to one of the drive current input terminals 91B, 92B, and 93B for each of the three phases of the motor 9B. The three second phase input terminals 126B are each connected to the virtual neutral output terminal 127B via fifth resistors R5. The virtual neutral output terminal 127B is connected to the second terminal of the differential amplifier circuits 125B.

Virtual neutral voltage corresponding to the average voltage of the coil terminal voltages of the three phases is input to the second terminal of the differential amplifier circuits 125B. Adjusting the resistance ratio between the fourth resistors R4 and fifth resistors R5 enables the virtual neutral voltage input to the second terminal to be set to a voltage value corresponding to the coil terminal voltage input to the first terminal. The differential amplifier circuits 125B thus output voltage values corresponding to the phase voltage of each of the two phases out of the three phases of the motor 9B, to inductive voltage input terminals 301B and 302B. The microcontroller 3B acquires phase voltage of two phases out of the three phases of the motor 9B, and thereby calculates the phase voltage of the remaining phase.

Inputting virtual neutral voltage to the differential amplifier circuits 125B as in the example in FIG. 9 enables two phase voltages of the three phases of the motor 9B to be input to the microcontroller 3B without obtaining voltage from a neutral point. Accordingly, the number of inductive voltage input terminals and the number of AD converters in the microcontroller 3B to be used for rotation state determining processing can be reduced.

Although the inverter in the above-described embodiment is a so-called low-side detecting type where the shunt resistance is disposed at the ground side of the switching devices, the present invention is not restricted to this. The inverter according to the present invention may be is a so-called high-side detecting type where the shunt resistance is disposed at the power source side of the switching devices.

Specific circuit configurations for realizing the parts of the motor drive control device may differ from the circuit configuration illustrated in FIG. 2. The components cited in the above-described embodiment and modifications may be combined as appropriate, to the extent that there is no conflict.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-14. (canceled)

15: A motor drive control device that outputs drive signals to a three-phase voltage type inverter that supplies drive current to a sensorless motor, the motor drive control device comprising:
a sensorless drive processing unit that performs sensorless drive processing by closed-loop speed control, based on voltage applied to shunt resistance of the inverter; and
a rotation state determining unit that determines a rotation state of the motor when the drive signals are not being output, based on inductive voltage of the motor,
wherein the sensorless drive processing unit starts the sensorless drive processing based on determination by the rotation state determining unit.

16: The motor drive control device according to claim 15, further comprising:
a forced-commutation processing unit that performs forced-commutation processing,
wherein one of
sensorless drive transition processing, in which transition is made to the sensorless drive processing by the sensorless drive processing unit, and
forced-commutation processing by the forced-commutation processing unit, is started, based on determination by the rotation state determining unit.

17: The motor drive control device according to claim 16,
wherein in the forced-commutation processing, the forced-commutation processing unit outputs a forced-commutation drive signal to the inverter, after having performed short braking processing as to the inverter.

18: The motor drive control device according to claim 16,
wherein, in a case where the rotation state determining unit determines that the motor speed belongs to a foreword rotation speed range within a predetermined speed range in a forward direction, sensorless drive transition processing of transitioning to the sensorless drive processing by the sensorless drive processing unit is started,
and wherein, in a case where the rotation state determining unit determines that the motor speed is smaller than the foreword rotation speed range and is in the forward direction, or is in a reverse direction, the forced-commutation processing by the forced-commutation processing unit is started.

19: The motor drive control device according to claim 15,
wherein the rotation state determining unit includes
an inductive voltage value determining unit that determines whether or not a low-speed rotation state where the voltage value of the inductive voltage is smaller than a predetermined magnitude, and
a rotation speed determining unit that, following the inductive voltage value determining unit having determined that the motor is not in a low-speed rotation state, calculates phase and rotation speed from the inductive voltage, and determines the rotation state of the motor based on the rotation speed.

20: The motor drive control device according to claim 18,
wherein, in a case where the rotation state determining unit determines that the motor speed is greater than the foreword rotation speed range and is in the forward direction, determination by the rotation state determining unit is continued without performing the sensorless drive processing or the forced-commutation processing.

21: The motor drive control device according to claim 15,
wherein the sensorless drive processing unit includes
a phase current restoration unit that calculates restored three-phase current based on voltage applied to the shunt resistance,
a Clarke transform unit that transforms the restored three-phase current into an α-β fixed coordinate system and calculates a fixed coordinate system current,
a Park transform unit that transforms the fixed coordinate system current into a d-q synchronous rotating coordinate system, and calculates a rotating coordinate system current,
a current control unit that calculates a rotating coordinate system voltage command value in the d-q synchronous rotating coordinate system, based on a target rotation speed and the rotating coordinate system current,
an inverse Park transform unit that transforms the rotating coordinate system voltage command value into an α-β fixed coordinate system and calculates a fixed coordinate system voltage command value,
an inverse Clarke transform unit that transforms the fixed coordinate system voltage command value into three phases, and calculates a phase voltage command value, and
a drive signal generating unit that generates the drive signal based on the phase voltage command value, and outputs to the inverter.

22: The motor drive control device according to claim 21,
wherein the shunt resistance is a resistance serially connected to a ground line shared by the three phases of the inverter,
and wherein the sensorless drive processing unit further includes
a first-order lag D-module filter that is interposed between the Clarke transform unit and the Park transform unit, and forms the fixed coordinate system current.

23: The motor drive control device according to claim 22,
wherein the sensorless drive processing unit further includes
a phase speed estimating unit that estimates phase and angular speed of the motor based on the fixed coordinate system current,
and wherein the fixed coordinate system current formed by the first-order lag D-module filter is input to the phase speed estimating unit.

24: A control method of a motor driven by a three-phase voltage type inverter having shunt resistance, the method comprising:
a) a step of determining a rotation state of the motor, based on inductive voltage of the motor;
b) a step of selecting activation processing of the motor from a plurality of activation processing methods, based on the determination results in the step a); and
c) a step of performing the activation processing method that has been selected, after the step b),
wherein the plurality of activation processing methods include
forced-commutation processing where braking and forced rotation of the motor is performed, and
sensorless drive transition processing, where the motor in a forward rotation state is transitioned to sensorless drive processing by closed-loop speed control.

25: The motor control method according to claim 24,
wherein, in step b),
in a case where determination is made in the step a) that the motor speed belongs to a foreword rotation speed range within a predetermined speed range in a forward direction, the sensorless drive transition processing is selected, and
in a case where determination is made in the step a) that the motor speed is smaller than the foreword rotation speed range and is in the forward direction, or is in a reverse direction, the forced-commutation processing is selected.

26: The motor control method according to claim 25,
wherein the step a) includes
a1) a step of determining whether or not a voltage value of the inductive voltage is smaller than a predetermined magnitude,
a2) a step of calculating the motor speed from the inductive voltage, after determination has been made in the step a1) that the state is not the low-speed rotation state, and
a3) a step of determining the rotation state based on the motor speed calculated in the step a2).

27: The motor control method according to claim 24,
wherein the forced-commutation processing further includes
d) a step of performing short braking at the inverter, and
e) a step of outputting a forced-commutation drive signal to the inverter.

28: The motor control method according to claim 27,
wherein the forced-commutation processing further includes
f) a step of detecting a position of the motor, by outputting a weak electrical signal to the inverter after the step d) and before the step e).
